(19) United States
(12) Patent Application Publication
(10) Pub. No.: US 2018/0188708 A1
(43) Pub. Date: Jul. 5, 2018

(54) COMMAND VALUE GENERATOR

(71) Applicant: Mitsubishi Electric Corporation, Chiyoda-ku (JP)

(72) Inventors: Toshihiro AZUMA, Tokyo (JP); Tsuyoshi KUMAZAWA, Tokyo (JP); Akihiko KOIDE, Tokyo (JP); Wenjuan WANG, Aichi (JP)

(73) Assignee: Mitsubishi Electric Corporation, Chiyoda-ku (JP)

(21) Appl. No.: 15/580,701

(22) PCT Filed: Jun. 16, 2015
(86) PCT No.: PCT/JP2015/067311

§ 371 Date: Dec. 8, 2017

(51) Int. Cl. G05B 19/404; G05B 19/402

(52) U.S. Cl. CPC G05B 19/404; G05B 2219/39177; G05B 19/402

(57) ABSTRACT

A command value generator includes: a target path and tolerance range changing unit changing at least one of the target path and a range of tolerance based on the machining error; a response path calculation unit calculating a response error and a response path; a path comparison unit calculating an error between the response path and the target path and determining whether the calculated error falls within the range of tolerance; a temporary command path holding unit holding the target path as a temporary command path; and a command path correction unit correcting the temporary command path. The temporary command path is corrected based on the response error when determining the calculated error not to fall within the range of tolerance, and a corrected temporary command path is held in the temporary command path holding unit.

### FIELD

The present invention relates to a command value generator that generates a command value for a machine equipped with a drive system.

### BACKGROUND

Use has been made of a conventional technique for eliminating an error such as a response delay caused by characteristics of a control target, in which a command corrected so that a response result of the control target follows a target path is generated. In particular, a technique for correcting a command position of a tool has been used in a field of grinding or lathe-turning a non-true circular shape in order to realize machining at high speed and with high accuracy. There is a cam grinding machine described in Patent Literature 1 used for such a technique.

Patent Literature 1 discloses a technique of a cam grinding machine that machines a cam surface into a desired cam profile by a plurality of grinding operations on the basis of control data stored in advance according to the desired cam profile and indicating a relationship between an angle of rotation of a main shaft and a feed rate of a grinding wheel. The cam grinding machine obtains a difference between a feed rate of the grinding wheel in the control data and a feed rate of the grinding wheel in an actual grinding operation, and corrects the control data to be used in a next grinding operation on the basis of the difference.

### CITATION LIST

### Patent Literature

Patent Literature 1: Japanese Patent Application Laid-Open No. H4-201058

### SUMMARY

### Technical Problem

However, the cam grinding machine described in Patent Literature 1 does not distinguish an error associated with the response delay caused by processing performed within a controller, an error caused by characteristics of the control target, and an error caused by a disturbance such as a reaction force generated at the time of machining. Therefore, after performing actual machining on some material according to a command value, the cam grinding machine likely repeats the operation of correcting a command value and performing actual machining on the material according to the corrected command value for a number of times.

The present invention has been made in view of the above circumstances, and its object is to provide a command value generator which can reduce the number of corrections of a command value.

### Solution to Problem

In order to solve the above-mentioned problem and achieve the object, the present invention provides a command value generator comprising: a target path and tolerance range input unit to receive a target path on which a control target operates and a range of tolerance with respect to the target path; a target path and tolerance range holding unit to hold the target path and the range of tolerance; a machining error model input unit to calculate a machining error in each section of the target path; a target path and tolerance range changing unit to change at least one of the target path and the range of tolerance held in the target path and tolerance range holding unit on the basis of the machining error; a response path calculation unit to calculate a response error and a response path; a path comparison unit to calculate an error between the response path and the target path held in the target path and tolerance range holding unit and determine whether the calculated error falls within the range of tolerance held in the target path and tolerance range holding unit; a temporary command path holding unit to hold the target path held in the target path and tolerance range holding unit as a temporary command path; a command path output unit to output the temporary command path held in the temporary command path holding unit to an outside as a command path; and a command path correction unit to correct the temporary command path, wherein the command path correction unit corrects the temporary command path held in the temporary command path holding unit on the basis of the response error when it is determined that the error calculated by the path comparison unit does not fall within the range of tolerance held in the target path and tolerance range holding unit, and a temporary command path obtained after the correction is held in the temporary command path holding unit.

### Advantageous Effects of Invention

The command value generator according to the present invention can reduce the number of corrections of a command value.

### BRIEF DESCRIPTION OF DRAWINGS

FIG. 1 is a configuration diagram of a command value generator according to a first embodiment.

FIG. 2 is a view illustrating arrangement of an axis of a machine tool performing non-true circular shape machining according to the first embodiment.

FIG. 3 is a view illustrating a shape of a piston.

FIG. 4 is a cross-sectional view of a tool and a material whose side is not cut off.

FIG. 5 is a diagram illustrating a target path and a response path on a CX plane when a controller and a control target have a response delay.

FIG. 6 is a cross-sectional view of a tool and a material whose side is cut off.

FIG. 7 is a diagram illustrating a target path and a response path on the CX plane when true-circular machining is performed on a shape having a side cut off.

FIG. 8 is a diagram illustrating a target path and a response path on the CX plane when the controller and the control target have a response delay and at the same time non-true circular machining is performed on a shape having a side cut off.

FIG. 9 is a diagram illustrating a target path and a response path on a CX plane when the target path is changed on the basis of an error caused by a disturbance at the time of machining.

FIG. 10 is a diagram illustrating a target path on the CX plane when a range of tolerance is changed on the basis of the error caused by the disturbance at the time of machining.

FIG. 11 is a diagram illustrating a target path and a response path on the CX plane when an abrupt change in the target path is not controlled in changing the target path on the basis of the error caused by the disturbance at the time of machining.

FIG. 12 is a diagram illustrating a target path and a response path on the CX plane when the target path is changed on the basis of the error caused by the disturbance at the time of machining.

FIG. 13 is a flowchart for explaining an operation of the command value generator according to the first embodiment.

FIG. 14 is a diagram illustrating a target path and a response path on the CX plane when non-true circular machining is performed on a shape whose side is cut off.

FIG. 15 is a configuration diagram of a command value generator according to a second embodiment.

FIG. 16 is a flowchart for explaining an operation of the command value generator according to the second embodiment.

FIG. 17 is a configuration diagram of a command value generator according to a third embodiment.

FIG. 18 is a flowchart for explaining an operation of the command value generator according to the third embodiment.

FIG. 19 is a diagram illustrating an example of a hardware configuration for implementing the command value generator according to the first embodiment, the command value generator according to the second embodiment, and the command value generator according to the third embodiment.

### DESCRIPTION OF EMBODIMENTS

Command value generators according to embodiments of the present invention will now be described in detail with reference to the drawings. Note that the present invention is not necessarily to be limited by these embodiments.

### First Embodiment

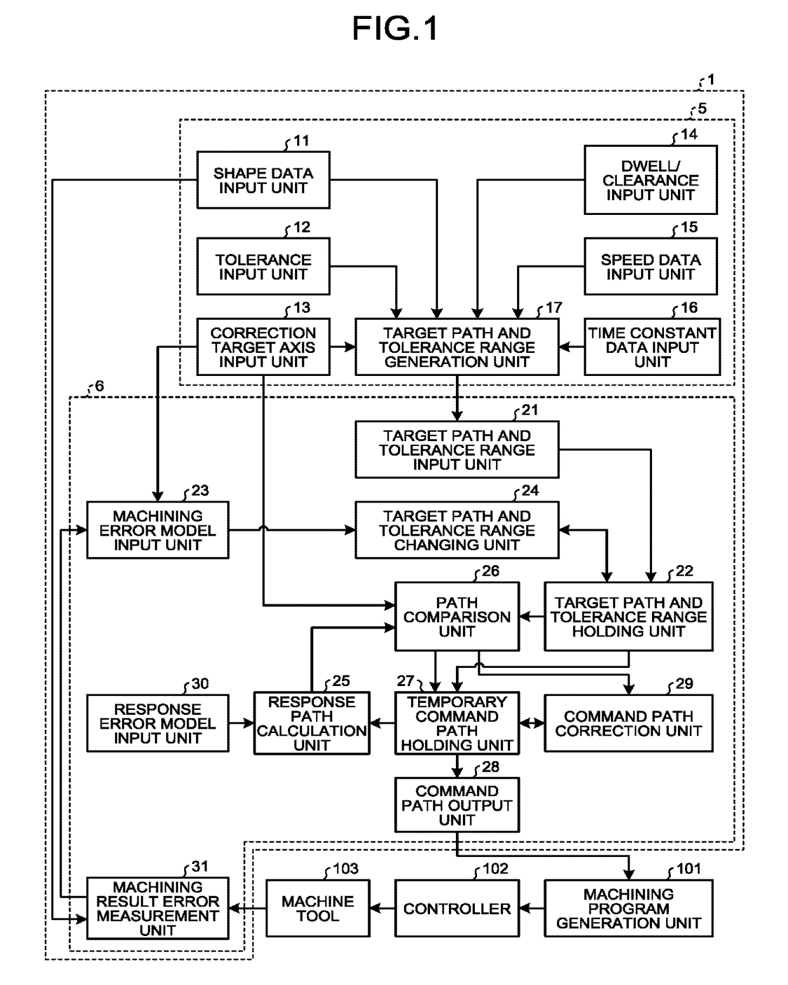

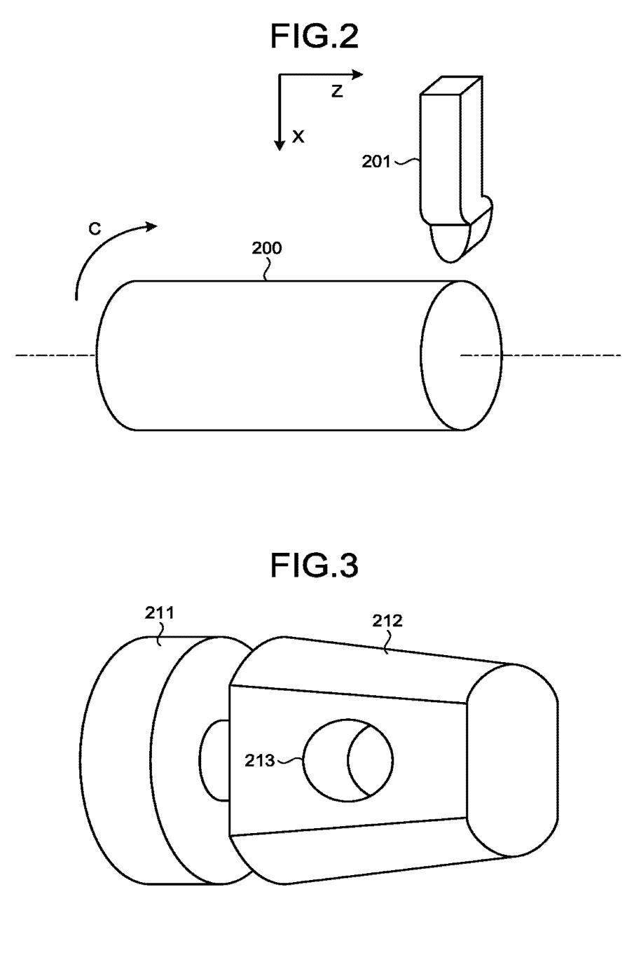

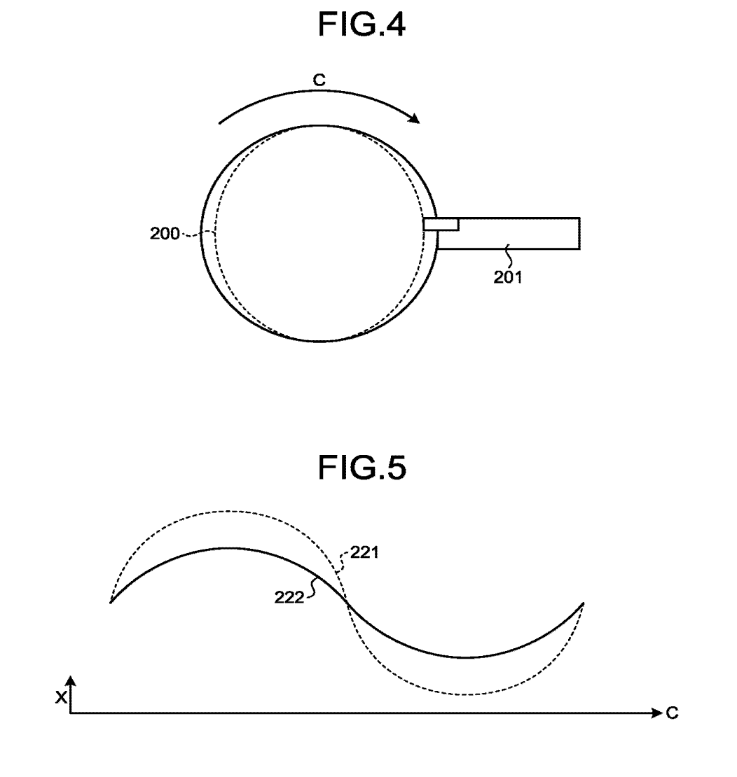

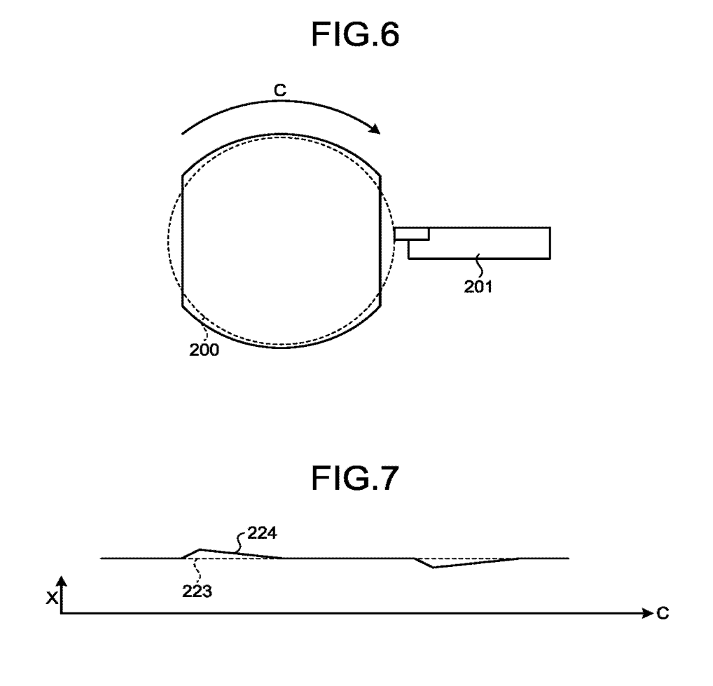

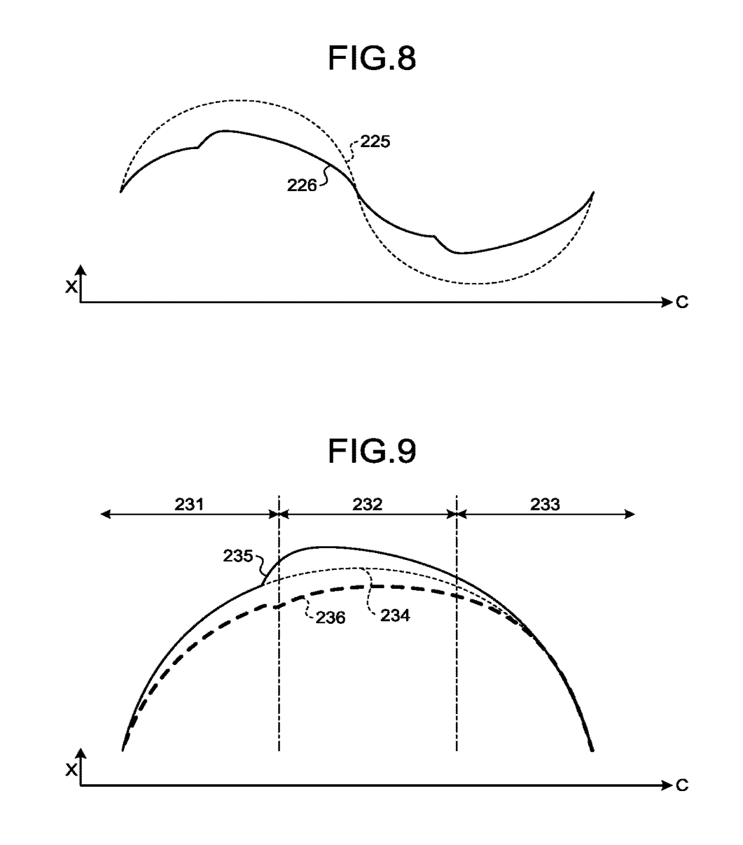

FIG. 1 is a diagram illustrating a configuration of a command value generator 1 according to a first embodiment. FIG. 2 is a view illustrating arrangement of an axis of a machine tool performing non-true circular machining. FIG. 3 is a view illustrating the shape of a piston. FIG. 4 is a view showing a cross-section of a tool 201 and a material 200 whose side is not cut off. FIG. 5 is a diagram illustrating a target path and a response path on a CX plane when a controller and a machine tool that is a control target have a response delay. FIG. 6 is a view showing a cross-section of the tool 201 and the material 200 whose side of which is cut off. FIG. 7 is a diagram illustrating a target path and a response path on the CX plane when true-circular machining is performed on a shape having its side cut off. FIG. 8 is a diagram illustrating a target path and a response path on the CX plane when the controller and the machine tool that is the control target have a response delay and at the same time non-true circular machining is performed on a shape having its side cut off.

In the first embodiment, as illustrated in FIG. 2, a machine tool is assumed such that for non-true circular machining, there is C-axis that is a turning spindle on the side of the material 200, and there are a Z-axis that is a rectilinear axis parallel to a central axis of rotation of the turning spindle and an X-axis that is a rectilinear axis perpendicular to the central axis of rotation of the turning spindle on the side of the tool 201. However, a construction of the machine tool is not limited to the above-exemplified construction.

In the first embodiment, it is further assumed that non-true circular machining is performed on the shape of a piston whose side is cut off as illustrated in FIG. 3. A disturbance is caused due to collision between a machining tool and the material or the like in a transition zone between a cut-off part and a non-cut-off part. The reason why the material is cut off in advance is that the number of setups is reduced and improved accuracy and a reduced takt time is achieved by finishing the cutoff at the time of machining the material into a rough product shape before a cross-section of the material is finally machined in form of a non-true circle.

The shape of the piston will now be described. The piston is formed of a lid portion 211 for compressing gas in a cylinder, a skirt portion 212 for attaching a connecting rod to be connected with a crankshaft and the like, and a mounting hole 213 for the connecting rod. The lid portion 211 generally has a groove for fitting therein a piston ring, and each of parts of the portion delimited by the groove has a different cross-sectional shape, some of the parts having a shape of a perfect circle but some other of the parts having a non-true circular shape.

The skirt portion 212 has a non-true circular cross section which changes gradually along the axial direction of the piston. The side part of the skirt portion 212 is cut off in order to attach the connecting rod. Note that FIG. 3 provides enhanced illustration of how the shape of the skirt portion 212 changes in the axial direction of the piston, but actual change of the shape is not as extreme as the illustration.

The skirt portion 212 generally has a shape formed by cutting off the side of a hollow conical shape. The cross section is non-true circular and changes in shape along the axial direction of the piston because the piston is designed to have an optimum tolerance with respect to the cylinder after thermal expansion at a temperature when the piston operates in a steady state.

Moreover, in machining of a piston, there are caused an error associated with a response delay caused by processing performed within a controller 102, an error caused by the characteristics of a machine tool 103 that is a control target, and an error caused by a disturbance such as a reaction force occurring at the time of machining, when performing a non-true circular finishing process on a part to have a non-true circular cross-section after machining the material into a shape close to a finished product with a true-circular cross-section.

Here, an error caused in machining the cross section of a part of the material, a side of which is not cut off, will be described with reference to FIGS. 4 and 5. As illustrated in FIG. 5, an error between a target path 221 and a response path 222 mainly results from the error associated with the response delay caused by the processing performed within the controller 102 and the error caused by the characteristics of the machine tool 103 that is a control target.

The error caused in machining the cross section of a part, the side of which is cut off, will be described with reference to FIG. 6. The error caused by the disturbance based on reaction force received from the material when a tool approaches a part of the material, the side of which is not cut off, from a part of the material, the side of which is cut off, cannot be ignored although such an error is relatively small with respect to the error associated with the response delay caused by the processing performed within the controller 102 and the error caused by the characteristics of the machine tool 103 that is the control target.

The error caused in performing non-true circular machining on a part, the side of which is cut off, will be described with reference to FIGS. 7 and 8. The figure illustrates how a response path 224 leaves a target path 223 as an error is caused by a disturbance due to a collision of the tool with a part of the material corresponding to a boundary between an uncut part, the side of which is cut off, and a cut part, and thereafter overlaps with the target path 223 as the error gradually converges by means of a feedback loop in a control system.

Therefore, the relationship between a target path 225 and a response path 226 in non-true circular machining of the part, the side of which cut off, is represented as illustrated in FIG. 8, which corresponds to a combination of FIGS. 5 and 7.

A correction needs to be made a plurality of times in order to use a command value to correct the error associated with the response delay caused by the processing performed within the controller 102 and the error caused by the characteristics of the machine tool 103 that is the control target. This is because, even if an error value associated with the response delay is added to the command value, the value obtained by the addition is not reflected directly on the response path but what is reflected on the response path is just the amount corresponding to the value obtained by the addition plus the response delay.

The command value generator 1 according to the first embodiment can reduce the number of corrections made to the command value when machining a material having a complicated shape such as a piston, and thus does not repeat actual machining a number of times. Specific configuration and operation of the command value generator 1 will be described below.

The command value generator 1 includes an input unit 5 to which data is inputted by a user, and a command value generation unit 6 that generates a command path that is a command value.

The configuration of the input unit 5 will now be described. The input section 5 includes a shape data input unit 11 to which shape data is inputted, a tolerance input unit 12 to which a tolerance is inputted, a correction target axis input unit 13 to which an axis to be corrected is inputted, a dwell/clearance input unit 14 to which a dwell speed and a clearance distance are inputted, a speed data input unit 15 to which a speed of each axis for each section of shape data is inputted, a time constant data input unit 16 to which a time constant is inputted, and a target path and tolerance range generation unit 17 that generates the target path and the range of tolerance.

The shape data input unit 11 receives shape data of a machining result based on a user's operation, and outputs the shape data to the target path and tolerance range generation unit 17 and a machining result error measurement unit 31.

The tolerance input unit 12 receives a tolerance of the shape data at each location based on a user's operation, and outputs the tolerance to the target path and tolerance range generation unit 17.

The correction target axis input unit 13 receives an axis targeted for correction based on a user's operation, and outputs the targeted axis to the target path and tolerance range generation unit 17, a machining error model input unit 23, and a path comparison unit 26.

The dwell/clearance input unit 14 receives a dwell speed and a clearance distance based on a user's operation, and outputs the dwell speed and the clearance distance to the target path and tolerance range generation unit 17.

The speed data input unit 15 receives speed data of each axis for each section of the shape data based on a user's operation, and outputs the speed data to the target path and tolerance range generation unit 17.

The time constant data input unit 16 receives a time constant of each axis based on a user's operation, and outputs the time constant of each axis to the target path and tolerance range generation unit 17.

The target path and tolerance range generation unit 17 generates a target path and a range of tolerance on the basis of the shape data inputted from the shape data input unit 11, the tolerance amount inputted from the tolerance input unit 12, the targeted axis inputted from the correction target axis input unit 13, the dwell speed and clearance distance inputted from the dwell/clearance input unit 14, the speed data of each axis for each section of the shape data inputted from the speed data input unit 15, and the time constant of each axis inputted from the time constant data input unit 16. The target path and tolerance range generation unit 17 outputs the generated target path and range of tolerance to a target path and tolerance range input unit 21.

Here, an example of a specific method of generating the target path and the range of tolerance will be described. The target path and tolerance range generation unit 17 generates cross-sectional shape data for each distance of movement in the Z-axis while one rotation is made in the C-axis with respect to a shape obtained by adding an extended shape corresponding to a clearance distance to both ends of the shape data, and interpolates between one and the other of the cross-sectional shape data to generate a target path for the machine tool 103 to take. On the basis of the speed data, the target path and tolerance range generation unit 17 calculates a Z-axis position and a C-axis position for each cycle in which a command is provided to the controller 102, and generates a move command or move commands for the Z-axis and the C-axis.

The target path and tolerance range generation unit 17 adds a C-axis move command corresponding to the dwell speed in front of and behind the generated Z-axis position and C-axis position. The target path and tolerance range generation unit 17 calculates a position obtained by performing acceleration/deceleration processing on each of the Z-axis position and the C-axis position according to the time constant data. The target path and tolerance range generation unit 17 acquires cross-sectional shape data corresponding to a position in front of and behind the Z-axis position obtained after the acceleration/deceleration processing, and calculates the X-axis position at an angle corresponding to the C-axis position obtained after the acceleration/deceleration processing from each of the cross-sectional shape data in front of and behind the Z-axis position. On the basis of the relationship between the positions in the Z direction of the cross-sectional shape data in front of and behind the Z-axis position and the Z position calculated after the acceleration/deceleration processing, the target path and tolerance range generation unit 17 performs interpolation and calculates an X-axis position corresponding to the Z-axis position and the C-axis position calculated after the acceleration/deceleration processing, from the X-axis position calculated from the cross-sectional shape data in front of and behind the Z-axis position. Then, the target path and tolerance range generation unit 17 regards the X-axis position, the C-axis position, and the Z-axis position, which have been calculated, as a target path, and calculates a range of tolerance in each section of the target path according to the tolerance data.

Next, the configuration of the command value generation unit 6 will be described. The command value generation unit 6 includes: the target path and tolerance range input unit 21 to which a target path and a range of tolerance are inputted; a target path and tolerance range holding unit 22 that holds a target path and a range of tolerance; a machining error model input unit 23 to which a machining error is inputted; a target path and tolerance range changing unit 24 that changes a target path and a range of tolerance; a response path calculation unit 25 that calculates a response path; a path comparison unit 26 that calculates an error between a target path and a response path and determines whether the calculated error falls within the range of tolerance; a temporary command path holding unit 27 that holds a temporary command path; a command path output unit 28 that outputs a command path; a command path correction unit 29 that corrects the temporary command path; a response error model input unit 30 to which model information is inputted; and the machining result error measurement unit 31 that measures a machining error.

The target path and tolerance range input unit 21 receives a target path and a range of tolerance on which the machine tool 103 operates from the target path and tolerance range generation unit 17, and outputs the target path and the range of tolerance to the target path and tolerance range holding unit 22. The range of tolerance means a range of error allowed with respect to the target path.

The target path and tolerance range holding unit 22 holds the target path and the range of tolerance, and outputs the target path and the range of tolerance to the target path and tolerance range changing unit 24, the path comparison unit 26, and the temporary command path holding unit 27.

The machining error model input unit 23 calculates a machining error in each section of the target path on the basis of the machining error inputted from the machining result error measurement unit 31 and the axis to be corrected inputted from the correction target axis input unit 13. The machining error model input unit 23 outputs the machining error calculated for each section of the target path to the target path and tolerance range changing unit 24. The machining error model input unit 23 may also calculate a machining error on the basis of any one of a measurement result obtained when actual machining is performed on the control target with a command path generated such that the machining error becomes zero, the position of a machining tool, and a feedback position acquired from an actuator for operating the control target.

The machining error model input unit 23 may also be configured to receive, from the machining result error measurement unit 31, a disturbance the machining tool experiences at the time of machining, the disturbance being calculated on the basis of the command path generated such that the machining error becomes zero and a material physical property value that is determined by information inputted to a material shape input unit to which a shape of a material before machining is inputted, and information inputted to a material quality input unit to which at least one of a type of a material to be machined and a physical property value of the material is inputted. Note that the material shape input unit and the material quality input unit correspond to the shape data input unit 11.

The machining error model input unit 23 may also be configured to receive, from the machining result error measurement unit 31, a disturbance the machining tool experiences at the time of machining, the disturbance being calculated on the basis of the material physical property value determined by the information inputted to the material shape input unit and the information inputted to the material quality input unit, information inputted to a mechanical model input unit which receives, as an input, at least one of: the shape of the machining tool; the material quality of the machining tool; a physical property value of the material of the machining tool; a mechanistic model of a machine tool that is a control target; a physical property value of each mechanism of the machine tool; inertia of each mechanism of the machine tool; viscosity of each mechanism of the machine tool; and elasticity of each mechanism of the machine tool, and the command path generated such that the machining error becomes zero. Note that the material shape input unit, the material quality input unit, and the mechanical model input unit correspond to the shape data input unit 11.

Here, a first calculation method used to calculate the machining error in each section of the target path will be described. It is assumed hereinafter that the X-axis is an axis to be corrected. The machining result error measurement unit 31 measures a cross-sectional shape for a Z position of the machined material, calculates an error for an X position for each C position, and outputs the machining error to the machining error model input unit 23. The machining error model input unit 23 interpolates an error for the X position for each C position, that is the machining error, in the Z positional direction, and outputs the generated error for the X position for each ZC position to the target path and tolerance range changing unit 24.

Next, a second calculation method used to calculate the machining error in each section of the target path will be described. It is assumed hereinafter that the X-axis is an axis to be corrected. The machining result error measurement unit 31 performs three-dimensional scanning on the machined material, calculates an error for the X position with respect to three-dimensional CAD data of a desired product shape for each ZC position, and outputs the machining error to the machining error model input unit 23. The machining error model input unit 23 outputs the machining error being the error at the X position for each ZC position to the target path and tolerance range changing unit 24.

Next, a third calculation method used to calculate the machining error in each section of the target path will be described. It is assumed hereinafter that the X-axis is an axis to be corrected. The machining result error measurement unit 31 stores sensor information and feedback data of the machine tool 103, estimates the shape of a machined result by calculating the position of the tip of the tool on the basis of the sensor information and the feedback data, calculates an error for the X position for each ZC position, and outputs the machining error to the machining error model input unit 23. The machining error model input unit 23 outputs the error for the X position for each ZC position, that is a machining error, to the target path and tolerance range changing unit 24. Note that a method of calculating the machining error in each section of the target path is not limited to the first, second, and third calculation methods. The axis to be corrected is not limited to the X-axis, either.

The target path and tolerance range changing unit 24 changes at least one of the target path and tolerance range read from the target path and tolerance range holding unit 22 on the basis of the machining error in each section of the target path inputted from the machining error model input unit 23. The target path and tolerance range changing unit 24 may change both the target path and the range of tolerance on the basis of the machining error in each section of the target path. The target path and tolerance range changing unit 24 outputs the target path and range of tolerance obtained after the change to the target path and tolerance range holding unit 22.

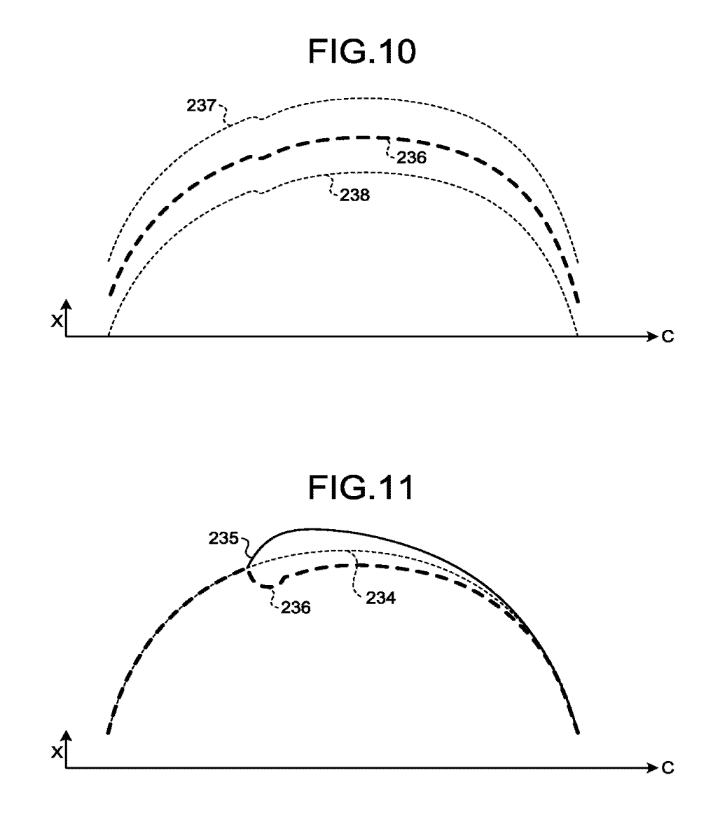

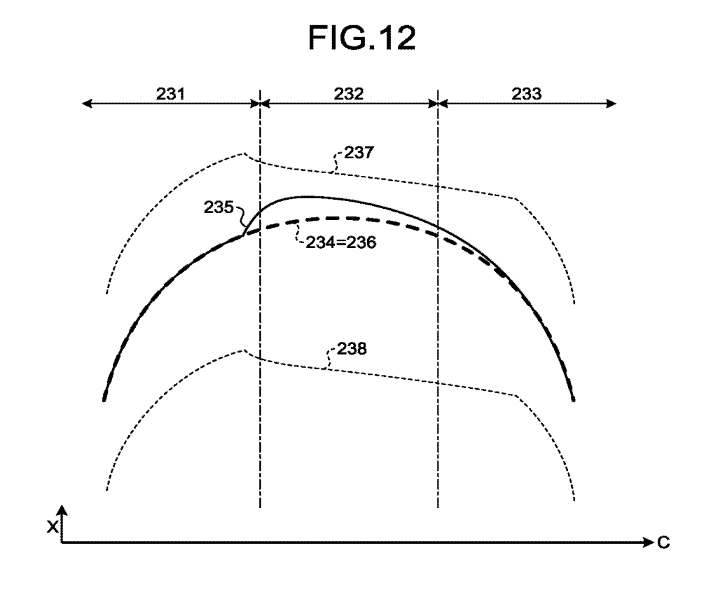

Here, an example of a specific method of changing the target path and the range of tolerance will be described with reference to FIGS. 9 to 12. In the following description, it is assumed that setting of the range of tolerance regarding whether correction is required or not required in each section of a target shape is performed in advance in the tolerance input unit 12 by a user's operation. FIG. 9 is a diagram illustrating a target path and a response path on a CX plane when the target path is changed on the basis of an error caused by a disturbance at the time of machining. FIG. 10 is a diagram illustrating a target path on the CX plane when the range of tolerance is changed on the basis of the error caused by the disturbance at the time of machining. FIG. 11 is a diagram illustrating a target path and a response path on the CX plane when the target path is changed on the basis of the error caused by the disturbance at the time of machining. Note that FIG. 11 illustrates an example in which an abrupt change in the target path is not controlled. FIG. 12 is a diagram illustrating a target path and a response path on the CX plane when the target path is changed on the basis of the error caused by the disturbance at the time of machining.

For example, setting such that a correction is not required for a cross section of a part, the side of which is cut off as illustrated in FIG. 6 is can be realized, because followability to the target path is not important.

The target path and tolerance range changing unit 24 changes a target path 234 to a target path 236 as illustrated in FIG. 9 in a section 232 requiring correction, on the basis of a difference between the target path 234 and a response path 235 to which the machining error has been added. The target path and tolerance range changing unit 24 also changes an upper limit 237 and a lower limit 238 of the range of tolerance by the same amount, as illustrated in FIG. 10.

Then, in a section 231 and a section 233 requiring no correction, the target path and tolerance range changing unit 24 changes the target path in a boundary with the adjacent section 232 requiring correction by the amount equal to the amount of change in the target path in the section requiring correction, and performs correction such that the amount of change becomes close to zero as the object gets farther away from the boundary, specifically as the object gets closer to a middle point of the section requiring no correction.

As a result, the target path and tolerance range changing unit 24 can prevent an abrupt change in the target path compared to a case where the target path is simply changed by the amount corresponding to the error as illustrated in FIG. 11, and can increase the speed and stability of convergence.

Alternatively, as illustrated in FIG. 12, the target path and tolerance range changing unit 24 may be configured to change only the upper limit 237 and the lower limit 238 of the range of tolerance by the amount corresponding to the machining error without shifting the target path but with using the same path for the target path 234 before the change and the target path 236 after the change, namely without changing the target path. The target path and tolerance range changing unit 24 can thus prevent the target path from abruptly changing as with the aforementioned example, and can keep an error with respect to the target path within the range of tolerance that is set initially, even when an error corresponding to the machining error is further added to a predicted response path at the time of generating a command path, because the range of tolerance is changed by the amount corresponding to the machining error.

The response path calculation unit 25 calculates a response error on the basis of response error model information inputted from the response error model input unit 30. The response path calculation unit 25 calculates a response path on the basis of the temporary command path inputted from the temporary command path holding unit 27 and the response error. The response path calculation unit 25 outputs the response error and the response path to the path comparison unit 26.

For the response error model information, at least the followings may be used: a model parameter of an element related to the viscosity of the machine tool 103; a model parameter of an element related to the elasticity of the machine tool 103; a model parameter related to an operation of the machine tool 103 at the time of axis inversion; a model parameter related to the influence of a thermal displacement on the machine tool 103; a model parameter related to the reaction force caused at the time of machining by the machine tool 103; a model parameter for representing the mechanism of the machine tool 103; a model parameter for representing a frequency response characteristic of the machine tool 103; a position feedback loop gain of the controller 102 controlling the machine tool 103; a speed feedback loop gain of the controller 102; a current feedback loop gain of the controller 102; other integral elements and derivative elements in the feedback loop of the controller 102; parameters of various kinds of filters of the controller 102; a model parameter of an element related to the mass of the machine tool 103; a parameter related to processing performed within the controller 102 to compensate for the influence of the inertia; a parameter related to processing performed within the controller 102 to compensate for the influence of the viscosity; a parameter related to processing performed within the controller 102 to compensate for the influence of the elasticity; a parameter related to processing performed within the controller 102 to compensate for the influence of the axis inversion; a parameter related to processing performed within the controller 102 to compensate for the influence of the thermal displacement; a parameter related to processing performed within the controller 102 to compensate for the influence of the reaction force caused at the time of machining; and a parameter related to filtering performed within the controller 102 to smooth the command path. Note that the response error model information is not limited to the above.

The path comparison unit 26 receives the response path from the response path calculation unit 25, receives the axis to be corrected from the correction target axis input unit 13, and receives the target path and the range of tolerance from the target path and tolerance range holding unit 22. The path comparison unit 26 calculates an error between the response path and the target path for the axis to be corrected, and determines whether the calculated error falls within the range of tolerance. The path comparison unit 26 outputs a result of determination as to whether the calculated error falls within the range of tolerance to the temporary command path holding unit 27. The path comparison unit 26 further outputs the result of determination as to whether the calculated error falls within the range of tolerance as well as the response error to the command path correction unit 29.

Alternatively, the path comparison unit 26 may be configured to calculate the error between the response path and the target path by simulating operations of the machine tool 103 and the controller 102 using a model and a parameter which are required to simulate at least one of: an operation caused by the viscosity of the machine tool 103; an operation caused by the elasticity of the machine tool 103; an operation exhibited by the machine tool 103 at the time of the axis inversion; an operation exhibited by the machine tool 103 in response to the influence of the thermal displacement; an operation exhibited by the machine tool 103 in response to the reaction force caused at the time of machining; an operation of position feedback loop processing performed within the controller 102 to control the machine tool 103; an operation of speed feedback loop processing performed within the controller 102; an operation of current feedback loop processing performed within the controller 102; an operation of processing performed within the controller 102 to compensate for the influence of the inertia; an operation of processing performed within the controller 102 to compensate for the influence of the viscosity; an operation of processing performed within the controller 102 to compensate for the influence of the elasticity; an operation of processing performed within the controller 102 to compensate for the influence of the axis inversion; an operation of processing performed within the controller 102 to compensate for the influence of the thermal displacement; an operation of processing performed within the controller 102 to compensate for the influence of the reaction force at the time of machining; and an operation of filtering performed within the controller 102 to smooth the command path.

The path comparison unit 26 may also be configured to calculate the error between the response path and the target path on the basis of the position of the machining tool or the feedback position acquired from the actuator for operating the machine tool 103 when the control target is actually operated in a non-machining state.

The temporary command path holding unit 27 reads the target path and the range of tolerance from the target path and tolerance range holding unit 22, holds the target path as an initial value of the temporary command path, and outputs the temporary command path to the response path calculation unit 25. The temporary command path holding unit 27 receives the result of determination as to whether the error between the response path and the target path falls within the range of tolerance from the path comparison unit 26. The temporary command path holding unit 27 outputs the temporary command path before correction to the command path correction unit 29, and receives a temporary command path obtained after the correction from the command path correction unit 29. The temporary command path holding unit 27 outputs the temporary command path to the command path output unit 28.

The command path output unit 28 receives the temporary command path from the temporary command path holding unit 27 and outputs the temporary command path as a command path to a machining program generation unit 101.

The command path correction unit 29 receives the response error and the result of determination as to whether the error between the response path and the target path falls within the range of tolerance from the path comparison unit 26, and receives the temporary command path from the temporary command path holding unit 27. When it is determined that the error between the response path and the target path does not fall within the range of tolerance, the command path correction unit 29 corrects the temporary command path on the basis of the response error, and outputs a temporary command path obtained after the correction to the temporary command path holding unit 27.

Here, a method of correcting the temporary command path will be described. The command path correction unit 29 may employ a method of shifting the temporary command path by the amount corresponding to the calculated response error. Alternatively, when the margin from the target path to the upper limit of the range of tolerance is different from the margin from the target path to the lower limit of the range of tolerance, the command path correction unit 29 may employ a method of changing the temporary command path by an amount smaller than the calculated error if the response path is shifted toward a side with the larger margin, and changing the temporary command path by an amount larger than the calculated error if the response path is shifted toward a side with the smaller margin. A method of correcting the temporary command path is not limited to these methods.

The response error model input unit 30 receives the response error model information used to calculate the response error caused by the characteristics of the controller 102 and the machine tool 103, and outputs the response error model information to the response path calculation unit 25. The response error model information may be the model parameter of the element related to the viscosity of the machine tool 103 and so on as described above, but is not limited to them.

The machining result error measurement unit 31 receives the material machined by the machine tool 103, receives the shape data from the shape data input unit 11, measures a machining error between the material and the shape data, and outputs the machining error to the machining error model input unit 23. Note that a method of measuring the machining error is not necessarily limited to the first, second, and third calculation methods described above.

The machining program generation unit 101 generates a machining program on the basis of the command path inputted from the command path output unit 28 and outputs the program to the controller 102.

According to the machining program, the controller 102 generates a signal for controlling devices constituting the machine tool 103, and outputs the signal to the machine tool 103.

The machine tool 103 machines the material on the basis of the signal inputted from the controller 102 and passes the machined material to the machining result error measurement unit 31.

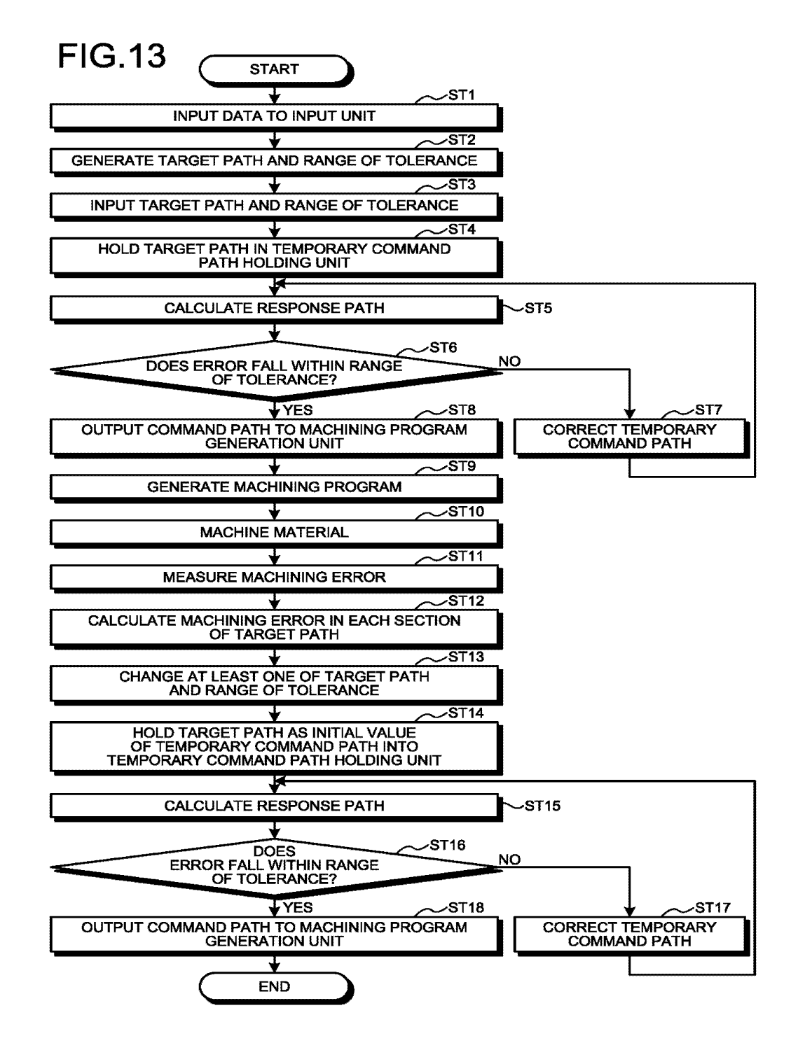

Here, the operation of the command value generator 1 will be described with reference to a flowchart illustrated in FIG. 13.

In step ST1, the input section 5 receives data from a user. Specifically, the shape data input unit 11 outputs the received shape data to the target path and tolerance range generation unit 17 and the machining result error measurement unit 31. The tolerance input unit 12 outputs a received tolerance to the target path and tolerance range generation unit 17. The correction target axis input unit 13 outputs a received correction targeted axis to the target path and tolerance range generation unit 17, the machining error model input unit 23, and the path comparison unit 26. The dwell/clearance input unit 14 outputs a dwell speed and a clearance distance which are inputted thereto, to the target path and tolerance range generation unit 17. The speed data input unit 15 outputs received speed data to the target path and tolerance range generation unit 17. The time constant data input unit 16 outputs a time constant of each axis that is inputted thereto, to the target path and tolerance range generation unit 17.

In step ST2, the target path and tolerance range generation unit 17 generates a target path and a range of tolerance on the basis of the input data.

In step ST3, the target path and tolerance range input unit 21 receives the target path and the range of tolerance from the target path and tolerance range generation unit 17. The target path and tolerance range input unit 21 outputs the target path and the range of tolerance to the target path and tolerance range holding unit 22.

In step ST4, the target path and tolerance range holding unit 22 holds the target path and the range of tolerance. The target path and tolerance range holding unit 22 outputs the target path to the temporary command path holding unit 27. The temporary command path holding unit 27 holds the target path as an initial value of a temporary command path.

In step ST5, the response path calculation unit 25 calculates a response path on the basis of the temporary command path inputted from the temporary command path holding unit 27 and a response error model inputted from the response error model input unit 30.

In step ST6, the path comparison unit 26 calculates an error between the response path and the target path for the axis to be corrected, and determines whether the calculated error falls within the range of tolerance. The processing proceeds to step ST7 if the error does not fall within the range of tolerance (No), or proceeds to step ST8 if the error falls within the range of tolerance (Yes).

In step ST7, when it is determined that the error between the response path and the target path does not fall within the range of tolerance, the command path correction unit 29 corrects the temporary command path on the basis of the response error, and outputs a temporary command path obtained after the correction to the temporary command path holding unit 27. The processing thereafter returns to step ST5.

In step ST8, the temporary command path holding unit 27 outputs a command path to the machining program generation unit 101 via the command path output unit 28.

In step ST9, the machining program generation unit 101 generates a machining program on the basis of the command path.

In step ST10, the controller 102 generates a signal for controlling devices constituting the machine tool 103 according to the machining program, and outputs the signal to the machine tool 103. The machine tool 103 machines the material according to the signal inputted from the controller 102.

In step ST11, the machining result error measurement unit 31 receives the material machined by the machine tool 103, receives shape data from the shape data input unit 11, and measures a machining error between the material and the shape data. The machining result error measurement unit 31 outputs the machining error to the machining error model input unit 23.

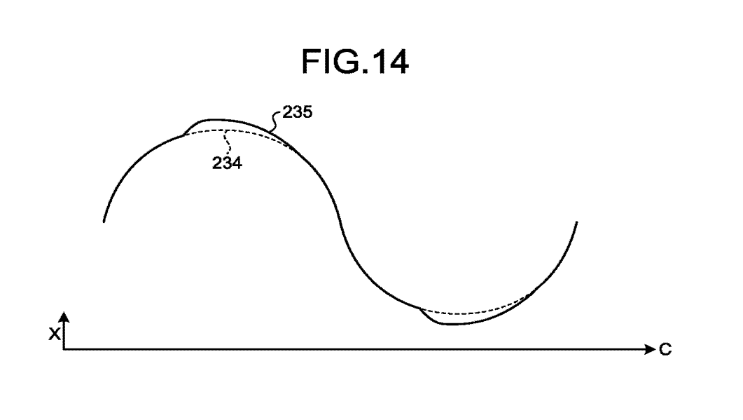

FIG. 14 is a diagram illustrating the target path and the response path on the CX plane when non-true circular machining is performed on the shape, the side of which is cut off. The error caused by the controller 102 and the machine tool 103 has already been corrected at the time of a process of step ST11, so that an error caused by a disturbance at the time of machining is the main cause of the error of the response path 235 with respect to the target path 234 as illustrated in FIG. 14.

In step ST12, the machining error model input unit 23 calculates a machining error in each section of the target path on the basis of the machining error inputted from the machining result error measurement unit 31 and the axis to be corrected, inputted from the correction target axis input unit 13. The machining error model input unit 23 outputs the machining error in each section of the target path to the target path and tolerance range changing unit 24.

In step ST13, the target path and tolerance range changing unit 24 changes at least one of the target path and the range of tolerance which are read from the target path and tolerance range holding unit 22 on the basis of the machining error in each section of the target path inputted from the machining error model input unit 23.

In step ST14, the target path and tolerance range holding unit 22 holds the target path and the range of tolerance. The target path and tolerance range holding unit 22 outputs the target path to the temporary command path holding unit 27. The temporary command path holding unit 27 holds the target path as an initial value of the temporary command path.

In step ST15, the response path calculation unit 25 calculates a response path on the basis of the temporary command path inputted from the temporary command path holding unit 27 and the response error model inputted from the response error model input unit 30.

In step ST16, the path comparison unit 26 calculates an error between the response path and the target path for the axis to be corrected, and determines whether the calculated error falls within the range of tolerance. The processing proceeds to step ST17 if the error does not fall within the range of tolerance (No), or proceeds to step ST18 if the error falls within the range of tolerance (Yes).

In step ST17, when it is determined that the error between the response path and the target path does not fall within the range of tolerance, the command path correction unit 29 corrects the temporary command path on the basis of the response error, and outputs a temporary command path obtained after the correction to the temporary command path holding unit 27. The processing thereafter returns to step ST15.

In step ST18, the temporary command path holding unit 27 outputs the temporary command path to the command path output unit 28. The command path output unit 28 outputs the temporary command path as a command path to the machining program generation unit 101.

Therefore, the command value generator 1 according to the first embodiment can acquire the error caused by the disturbance such as the reaction force caused at the time of machining in only one actual machining by correcting the error associated with the response delay caused by the processing performed within the controller 102 and the error caused by the characteristics of the control target, and then measuring the machining error. In other words, the command value generator 1 according to the first embodiment can correct all the errors in only one actual machining, the errors including the error associated with the response delay caused by the processing performed within the controller 102, the error caused by the characteristics of the control target, and the error caused by the disturbance such as the reaction force caused at the time of machining.

The command value generator 1 according to the first embodiment can perform stable correction even on the error caused by the disturbance at the time of machining, since the target path and tolerance range changing unit 24 changes at least one of the target path and the range of tolerance in such a manner that the target path is continuous as much as possible so as not to adversely affect convergence of the correction repeatedly.

Although the command value generator 1 according to the first embodiment uses the shape data of the workpiece or the like as an input so as to determine the target path, the generator 1 may be configured to use the path itself as the input. In the case of such a configuration, the target path and tolerance range generation unit 17 may perform acceleration/deceleration processing on the input path and set a path obtained after the acceleration/deceleration processing as an initial value of a corrected path and the target path.

The first embodiment assumes non-true circular shape machining, but can also be applied to machining other than non-true circular machining such as parts machining and die machining when an error caused by a disturbance at the time of machining has a large influence on the machining. In the case of such a configuration, the target path and tolerance range generation unit 17 may receive a path created by using an application such as computer aided manufacturing (CAM), perform acceleration/deceleration processing on the input path, and set the path obtained after the acceleration/deceleration processing as the initial value of the corrected path and the target path.

The target path and tolerance range input unit 21 or the target path and tolerance range changing unit 24 may be configured to specify the range of tolerance for each section of the target path. The command value generator 1 can thus guarantee the required accuracy and reduce the time required for command generation by decreasing the tolerance in a part where high accuracy is required while increasing the tolerance in another part where high accuracy is not required.

The target path and tolerance range input unit 21 or the target path and tolerance range changing unit 24 may also be configured to set whether correction is required for each section of the target path or not. The command value generator 1 thus does not perform correction on a section that is not actually machined in a case when the side of the workpiece has been cut off or the like case, thereby improving the accuracy more easily in a section requiring correction and making it possible to reduce the time required for command generation.

### Second Embodiment

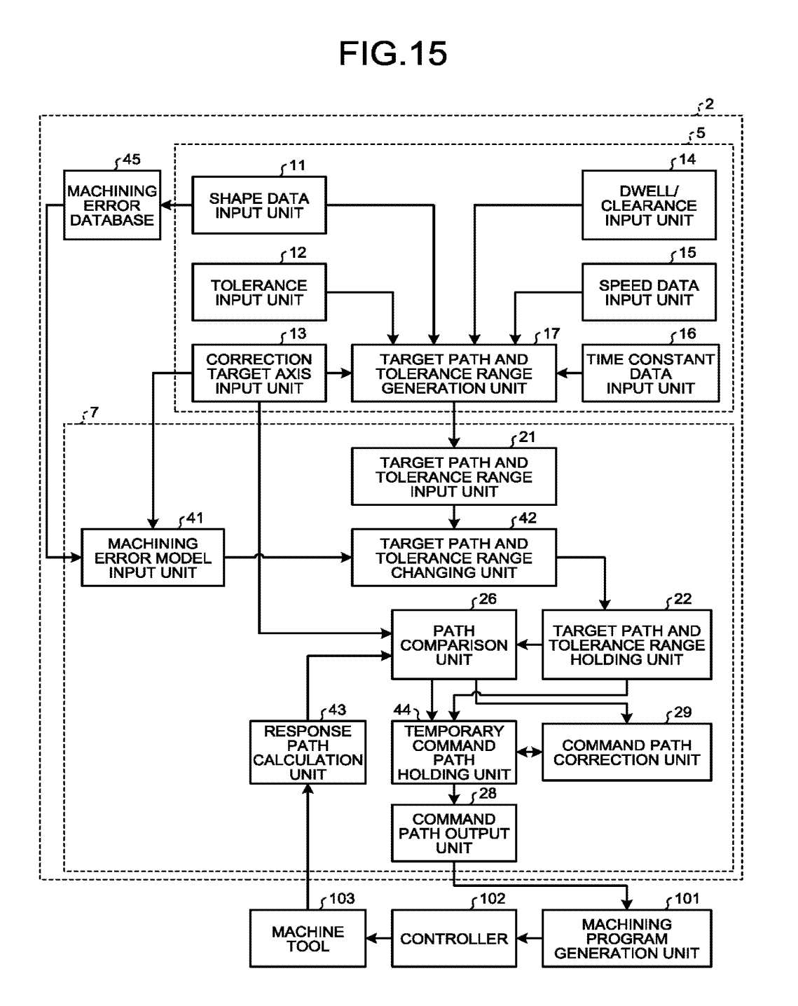

A second embodiment will now be described. FIG. 15 is a diagram illustrating the configuration of a command value generator 2 according to the second embodiment. The second embodiment assumes that a material is machined into a shape having both a part with the side being cut off and a part with the side not being cut off. The embodiment is not limited to such a shape, however.

The command value generator 2 according to the second embodiment is different from the command value generator 1 according to the first embodiment in terms of a configuration of a machining error model input unit 41, a target path and tolerance range changing unit 42, a response path calculation unit 43, a temporary command path holding unit 44, and a machining error database 45. Hereinafter, a configuration identical to the configuration of the command value generator 1 according to the first embodiment will be denoted by the same reference numeral as that assigned to such component in the first embodiment and will not be described therefor.

The command value generator 2 according to the second embodiment includes an input unit 5 to which data is inputted by a user, a command value generation unit 7 that generates a command path that is a command value, and the machining error database 45 that holds a machining error.

The command value generation unit 7 includes the machining error model input unit 41 to which a machining error is inputted, the target path and tolerance range changing unit 42 that changes a target path and a range of tolerance, the response path calculation unit 43 that calculates a response path, and the temporary command path holding unit 44 that holds a temporary command path.

The machining error model input unit 41 calculates a machining error in each section of the target path on the basis of the machining error inputted from the machining error database 45 and an axis to be corrected which is inputted from a correction target axis input unit 13. The machining error model input unit 41 outputs the machining error calculated for each section of the target path to the target path and tolerance range changing unit 42.

Here, a method of calculating the machining error in each section of the target path will be described. It is assumed hereinafter that the X-axis is the axis to be corrected. The machining error database 45 receives shape data of a workpiece from the shape data input unit 11, selects, from among cross-sectional shape patterns being held therein, a shape closest to the cross-sectional shape of the material to be machined in a predetermined Z position, and outputs an error in an X position for each C position registered with the selected shape to the machining error model input unit 41.

The machining error model input unit 41 interpolates the error in the X position for each C position in the direction of the Z position, and outputs the thus-generated error in the X position for each ZC position to the target path and tolerance range changing unit 42. Note that the cross-sectional shape to be registered in the machining error database 45 and the shape data to be inputted to the shape data input unit 11 are desirably of an elliptical shape, the side of which is cut off.

In addition, it is preferable that information on the rotational speed of a C-axis is registered in the machining error database 45 in advance along with the shape data, and a machining error dependent on the rotational speed is calculated. In comparing the shape data, similar shapes that are slightly different in size may be regarded as equal shapes, and a size ratio thereof may be added to the machining error.

An example of a method of registering the shape data and the machining error in the machining error database 45 includes a method of accumulating a cross-sectional shape in a predetermined Z position and a machining error from a measured result obtained when the machining error is calculated by the machining error model input unit 23 according to the first embodiment, and a method of inputting a theoretical value of the error in advance by a user. Note that the method of registering the shape data and the machining error described above is merely an example and does not limit the present invention. The axis to be corrected is not limited to the X-axis, either.

The target path and tolerance range changing unit 42 changes at least one of a target path and a range of tolerance which have been inputted from a target path and tolerance range input unit 21 on the basis of the machining error in each section of the target path inputted from the machining error model input unit 41. The target path and tolerance range changing unit 42 may change both the target path and the range of tolerance on the basis of the machining error in each section of the target path. The target path and tolerance range changing unit 42 outputs the target path and the range of tolerance obtained after the change to a target path and tolerance range holding unit 22. Note that a method of changing the target path and the range of tolerance may be equal to the changing method employed by the target path and tolerance range changing unit 24 according to the first embodiment described above, but the present invention is not limited to such changing method.

The response path calculation unit 43 receives sensor information and feedback data from a machine tool 103, calculates a response path on the basis of the information, and outputs the calculated response path to a path comparison unit 26. The sensor information can be information of an acceleration sensor, a laser measuring device, an image sensor, or the like. The feedback data can be data on a position feedback, a speed feedback, a current feedback, or the like.

The temporary command path holding unit 44 reads the target path and the range of tolerance from the target path and tolerance range holding unit 22, holds the target path as an initial value of a temporary command path, and outputs the temporary command path to a command path output unit 28. The temporary command path holding unit 44 receives, from the path comparison unit 26, a result of determination as to whether the error between the response path and the target path falls within the range of tolerance. The temporary command path holding unit 44 outputs the temporary command path before correction to a command path correction unit 29, and receives a temporary command path obtained after the correction from the command path correction unit 29.

The machining error database 45 holds information on a cross-sectional shape pattern and the machining error, and outputs the machining error to the machining error model input unit 41. The machining error database 45 may also be configured to have a correspondence relationship between the machining error and at least one of a machining method and the shape of the material before machining. In the case of such a configuration, when receiving the machining method or the shape of the material before machining, the machining error model input unit 41 refers to the machining error database 45 and reads a machining error corresponding to the machining method or the shape of the material before machining, which has been inputted.

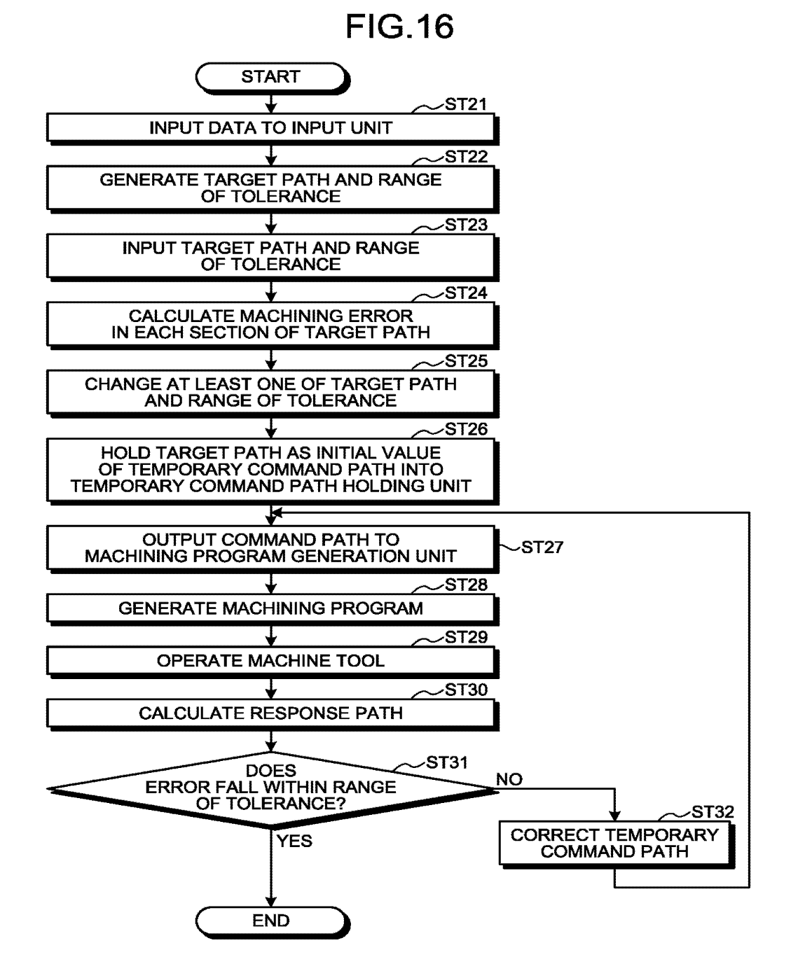

Here, the operation of the command value generator 2 will be described with reference to a flowchart illustrated in FIG. 16.

In step ST21, the input unit 5 receives data from a user. Specifically, the shape data input unit 11 outputs the inputted shape data to a target path and tolerance range generation unit 17 and the machining error database 45. The tolerance input unit 12 outputs the inputted tolerance to the target path and tolerance range generation unit 17. The correction target axis input unit 13 outputs a correction-targeted axis inputted thereto, to the target path and tolerance range generation unit 17, the path comparison unit 26, and the machining error model input unit 41. The dwell/clearance input unit 14 outputs a dwell speed and a clearance distance inputted thereto, to the target path and tolerance range generation unit 17. The speed data input unit 15 outputs speed data inputted thereto, to the target path and tolerance range generation unit 17. The time constant data input unit 16 outputs a time constant of each axis inputted thereto, to the target path and tolerance range generation unit 17.

In step ST22, the target path and tolerance range generation unit 17 generates a target path and a range of tolerance on the basis of the inputted data.

In step ST23, the target path and tolerance range input unit 21 receives the target path and the range of tolerance from the target path and tolerance range generation unit 17. The target path and tolerance range input unit 21 outputs the target path and the range of tolerance to the target path and tolerance range changing unit 42.

In step ST24, the machining error model input unit 41 calculates a machining error in each section of the target path on the basis of the machining error inputted from the machining error database 45 and the axis to be corrected inputted from the correction target axis input unit 13.

In step ST25, the target path and tolerance range changing unit 42 changes at least one of the target path and the range of tolerance inputted from the target path and tolerance range input unit 21 on the basis of the machining error in each section of the target path inputted from the machining error model input unit 41.

In step ST26, the target path and tolerance range holding unit 22 holds the target path and the range of tolerance. The target path and tolerance range holding unit 22 outputs the target path to the temporary command path holding unit 44. The temporary command path holding unit 44 holds the target path as an initial value of the temporary command path.

In step ST27, the temporary command path holding unit 44 outputs a command path to the machining program generation unit 101 via the command path output unit 28.

In step ST28, the machining program generation unit 101 generates a machining program on the basis of the command path.

In step ST29, the controller 102 generates a signal for controlling devices constituting the machine tool 103 according to the machining program, and outputs the signal to the machine tool 103. The machine tool 103 machines the material according to the signal inputted from the controller 102.

In step ST30, the response path calculation unit 43 receives sensor information and feedback data from the machine tool 103, and calculates a response path on the basis of the information. The response path calculation unit 43 outputs the calculated response path to the path comparison unit 26.

In step ST31, the path comparison unit 26 calculates an error between the response path and the target path for the axis to be corrected, and determines whether the calculated error falls within the range of tolerance. The processing proceeds to step ST32 if the error does not fall within the range of tolerance (No), or if the error falls within the range of tolerance (Yes), then the processing ends assuming that correction of the command path has been completed.

In step ST32, when it is determined that the error between the response path and the target path does not fall within the range of tolerance, the command path correction unit 29 corrects the temporary command path on the basis of the response error, and outputs a temporary command path obtained after the correction to the temporary command path holding unit 44. The processing thereafter returns to step ST27.

It is preferred that the command value generator 2 according to the second embodiment independently holds the change made to the target path and the change made to the command path, calculates an amount of correction for some cross sections extracted in advance in a section of idle cutting before actual machining is started, and performs machining by using the amount of correction for the corresponding cross-sectional shape after actual machining is started.

Therefore, with the data to be inputted to the machining error model input unit 41 being the data held in the machining error database 45, the command value generator 2 according to the second embodiment can correct all errors without performing measurement on the result of actual machining, the errors including an error associated with a response delay caused by processing performed within the controller 102, an error caused by the characteristics of the machine tool 103, and an error caused by a disturbance such as a reaction force caused at the time of machining.

Moreover, the command value generator 2 according to the second embodiment calculates the response path by using the sensor information of the machine tool 103, and so the generator 2 is able to perform correction with high accuracy without considering modeling for calculating the response path and an accompanying error associated with the modeling.

### Third Embodiment

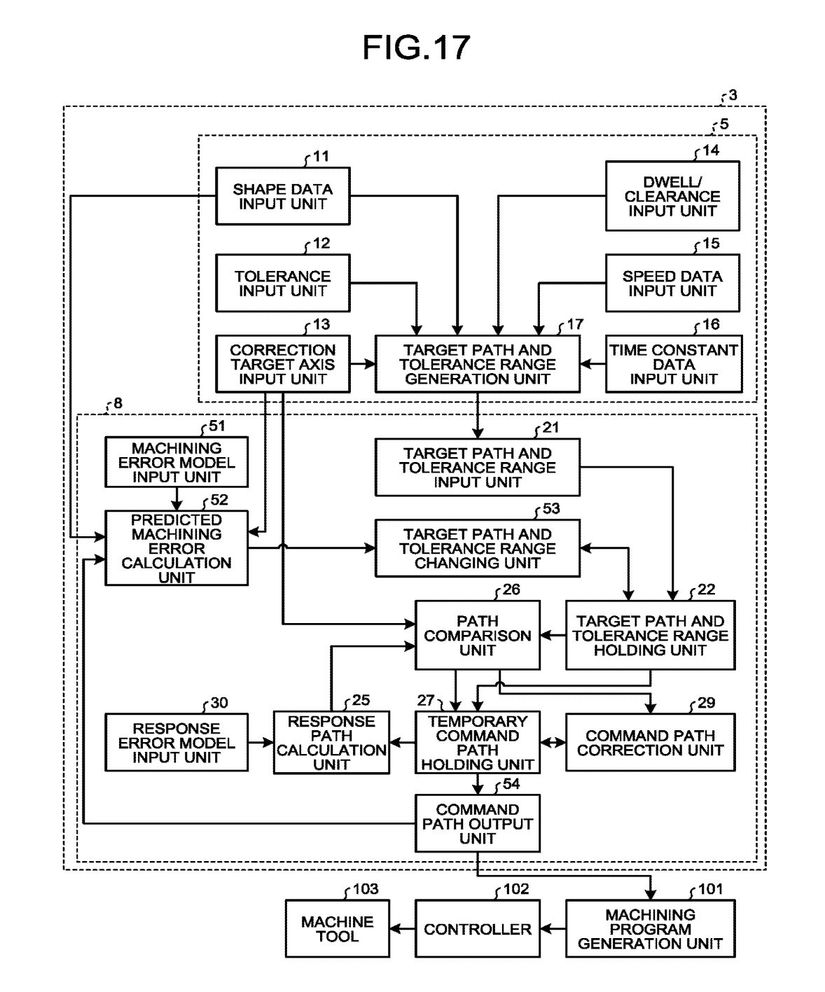

A third embodiment will now be described. FIG. 17 is a diagram illustrating the configuration of a command value generator 3 according to the third embodiment. The command value generator 3 according to the third embodiment is different from the command value generator 1 according to the first embodiment in terms of the configuration of a machining error model input unit 51, a predicted machining error calculation unit 52, a target path and tolerance range changing unit 53, and a command path output unit 54. Hereinafter, a configuration identical to the configuration of the command value generator 1 according to the first embodiment will be denoted by the same reference numeral as that assigned to such component in the first embodiment and thus will not be described therefor.

The command value generator 3 according to the third embodiment includes the input unit 5 to which data is input by a user, and a command value generation unit 8 that generates a command path that is a command value.

The command value generation section 8 includes the machining error model input unit 51 to which a machining error is inputted, the predicted machining error calculation unit 52 that calculates a predicted machining error in each section of a target path, the target path and tolerance range changing unit 53 that changes the target path and a range of tolerance, and the command path output unit 54 that outputs the command path.

The machining error model input unit 51 receives information necessary to predict and calculate a disturbance at the time of machining and outputs the information to the predicted machining error calculation unit 52. The information necessary for predicting and calculating the disturbance at the time of machining includes a physical property of the material, the shape of a machining tool, the material quality of the machining tool, a property value of the material of the machining tool, a mechanistic model of a machine tool 103, a physical property value of each mechanism in the machine tool 103, the inertia of each mechanism of the machine tool 103, the viscosity of each mechanism in the machine tool 103, the elasticity of each mechanism of the machine tool 103, and so on.

The predicted machining error calculation unit 52 receives the information necessary to predict and calculate the disturbance at the time of machining from the machining error model input unit 51, receives shape data of the material from a shape data input unit 11, receives the command path from the command path output unit 54, and receives an axis to be corrected from a correction target axis input unit 13, and then calculates a predicted machining error in each section of the target path. A method of predicting a machining error may be any of a method of calculating elastic deformation and plastic deformation of the material by employing a finite element method or the like, a method of modeling the dynamics of each part of the machine tool 103 and calculating a path of a tool on the basis of a reaction force caused when the tool cuts the material, a method of combining the aforementioned methods and calculating the elastic deformation and the plastic deformation of the material upon calculating the path of the tool on the basis of the reaction force caused at the time of cutting, and so on.

Whether the above modeling has sufficient accuracy can be checked by, for example, comparing a cross-sectional shape in a predetermined position with data from among the machining error database 45 according to the second embodiment, the database having a machining error accumulated, on the basis of a measured result obtained when the machining error is calculated by the machining error model input unit 23 according to the first embodiment. Note that this example does not limit the invention, and check of the accuracy may also be based on other experimental data or theory.

The target path and tolerance range changing unit 53 changes at least one of the target path and the range of tolerance read from a target path and tolerance range holding unit 22 on the basis of the predicted machining error in each section of the target path inputted from the predicted machining error calculation unit 52. The target path and tolerance range changing unit 53 may change both the target path and the range of tolerance on the basis of the predicted machining error in each section of the target path. The target path and tolerance range changing unit 53 outputs the target path and the range of tolerance obtained after the change to the target path and tolerance range holding unit 22. Although the method described in the first embodiment can be employed as a method of changing the target path and the range of tolerance, the present invention is not necessarily limited by said method.

The command path output unit 54 receives a temporary command path from a temporary command path holding unit 27 and outputs the temporary command path as a command path to the predicted machining error calculation unit 52 and the machining program generation unit 101.

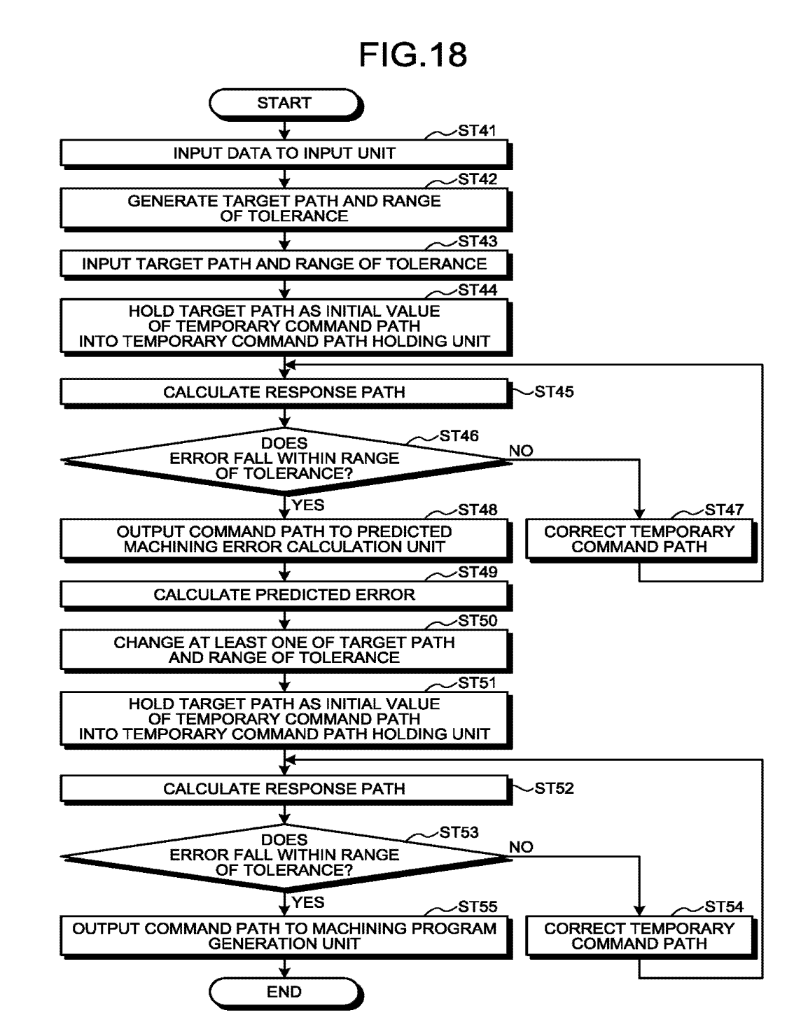

Here, the operation of the command value generator 3 will be described with reference to a flowchart illustrated in FIG. 18.

In step ST41, the input unit 5 receives data from a user. Specifically, the shape data input unit 11 outputs shape data input thereto, to a target path and tolerance range generation unit 17 and the predicted machining error calculation unit 52. The tolerance input unit 12 outputs a tolerance inputted thereto, to the target path and tolerance range generation unit 17. The correction target axis input unit 13 outputs a correction-targeted axis inputted thereto, to the target path and tolerance range generation unit 17, the path comparison unit 26, and the predicted machining error calculation unit 52. The dwell/clearance input unit 14 outputs a dwell speed and a clearance distance, which have been inputted thereto, to the target path and tolerance range generation unit 17. The speed data input unit 15 outputs speed data inputted thereto, to the target path and tolerance range generation unit 17. The time constant data input unit 16 outputs a time constant of each axis inputted thereto, to the target path and tolerance range generation unit 17.

In step ST42, the target path and tolerance range generation unit 17 generates a target path and a range of tolerance on the basis of the inputted data.

In step ST43, a target path and tolerance range input unit 21 receives the target path and the range of tolerance from the target path and tolerance range generation unit 17. The target path and tolerance range input unit 21 outputs the target path and the range of tolerance to the target path and tolerance range holding unit 22.

In step ST44, the target path and tolerance range holding unit 22 holds the target path and the range of tolerance. The target path and tolerance range holding unit 22 outputs the target path to the temporary command path holding unit 27. The temporary command path holding unit 27 holds the target path as an initial value of a temporary command path.

In step ST45, a response path calculation unit 25 calculates a response path on the basis of the temporary command path inputted from the temporary command path holding unit 27 and a response error model inputted from a response error model input unit 30.

In step ST46, the path comparison unit 26 calculates an error between the response path and the target path for the axis to be corrected, and determines whether the calculated error falls within the range of tolerance. The processing proceeds to step ST47 if the error does not fall within the range of tolerance (No), or proceeds to step ST48 if the error falls within the range of tolerance (Yes).

In step ST47, when it is determined that the error between the response path and the target path does not fall within the range of tolerance, the command path correction unit 29 corrects the temporary command path on the basis of the response error and outputs a temporary command path obtained after the correction to the temporary command path holding unit 27. The processing thereafter returns to step ST45.

In step ST48, the temporary command path holding unit 27 outputs the command path to the command path output unit 54. The command path output unit 54 outputs the command path to the predicted machining error calculation unit 52.

In step ST49, the predicted machining error calculation unit 52 calculates a predicted machining error in each section of the target path on the basis of the information which is inputted from the machining error model input unit 51 and is necessary to predict and calculate the disturbance at the time of machining, shape data of the material inputted from the shape data input unit 11, the command path inputted from the command path output unit 54, and the axis to be corrected inputted from the correction target axis input unit 13. The predicted machining error calculation unit 52 outputs the predicted machining error in each section of the target path to the target path and tolerance range changing unit 53.

In step ST50, the target path and tolerance range changing unit 53 changes at least one of the target path and the range of tolerance which are read from the target path and tolerance range holding unit 22 on the basis of the predicted machining error in each section of the target path, inputted from the predicted machining error calculation unit 52.

In step ST51, the target path and tolerance range holding unit 22 holds the target path and the range of tolerance. The target path and tolerance range holding unit 22 outputs the target path to the temporary command path holding unit 27. The temporary command path holding unit 27 holds the target path as an initial value of a temporary command path.

In step ST52, the response path calculation unit 25 calculates a response path on the basis of the temporary command path inputted from the temporary command path holding unit 27 and a response error model inputted from the response error model input unit 30.

In step ST53, the path comparison unit 26 calculates an error between the response path and the target path for the axis to be corrected, and determines whether the calculated error falls within the range of tolerance. The processing proceeds to step ST54 if the error does not fall within the range of tolerance (No), or the processing proceeds to step ST55 if the error falls within the range of tolerance (Yes).

In step ST54, when it is determined that the error between the response path and the target path does not fall within the range of tolerance, the command path correction unit 29 corrects the temporary command path on the basis of the response error and outputs a temporary command path obtained after the correction to the temporary command path holding unit 27. The processing thereafter returns to step ST52.

In step ST55, the temporary command path holding unit 27 outputs the temporary command path to the command path output unit 28. The command path output unit 28 outputs the temporary command path as a command path to the machining program generation unit 101.

Therefore, with the machining error predicted and calculated by the predicted machining error calculation unit 52, the command value generator 3 according to the third embodiment can correct all errors without performing actual machining, the errors including an error associated with a response delay caused by processing performed within the controller 102, an error caused by the characteristics of the machine tool 103, and an error caused by a disturbance such as a reaction force caused at the time of machining.

Moreover, the command value generator 3 according to the third embodiment need only perform once heavy computational load processing necessary to predict and calculate the machining error, such as processing of solving the dynamics in order to consider the dynamics of the machine tool 103, processing of solving the finite element method in order to consider the elastic-plastic deformation of the material model, or processing based on combination of these processings. Therefore, generator 3 can reduce the time required for generating the command path without needing to perform such a processing every time the command path is corrected. Note that the command value generator 3 according to the third embodiment is not limited by the aforementioned methods but may be configured to predict and calculate the machining error every time the command path is corrected, as necessary.

The command value generator 1 includes: the target path and tolerance range input unit 21 that receives a target path on which a control target operates and a range of tolerance with respect to the target path; the target path and tolerance range holding unit 22 that holds the target path and the range of tolerance; the machining error model input unit 23 that calculates a machining error in each section of the target path; the target path and tolerance range changing unit 24 that changes at least one of the target path and the range of tolerance held in the target path and tolerance range holding unit 22 on the basis of the machining error; the response path calculation unit 25 that calculates a response error and a response path; the path comparison unit 26 that calculates an error between the response path and the target path held in the target path and tolerance range holding unit 22 and determines whether the calculated error falls within the range of tolerance held in the target path and tolerance range holding unit 22; the temporary command path holding unit 27 that holds the target path held in the target path and tolerance range holding unit 22 as a temporary command path; the command path output unit 28 that outputs the temporary command path held in the temporary command path holding unit 27 to the outside as a command path; and the command path correction unit 29 that corrects the temporary command path. The command path correction unit 29 corrects the temporary command path held in the temporary command path holding unit 27 on the basis of the response error when it is determined that the error calculated by the path comparison unit 26 does not fall within the range of tolerance held in the target path and tolerance range holding unit 22, and a temporary command path obtained after the correction is held in the temporary command path holding unit 27.

The command value generator 1 thus generates a command separately for an error caused by the characteristics of the machine tool 103 that is the control target and the controller 102 and for an error associated with a disturbance caused by the machining method or the shape of the material before machining, so that test machining for acquiring the error at the time of machining need only be performed once and the time required for generating the command path can be greatly reduced.

The path comparison unit 26 is configured to calculate the error between the response path and the target path held in the target path and tolerance range holding unit 22 by simulating an operation of the control target and the controller with a model and a parameter required to simulate at least one of: an operation caused by viscosity of the control target; an operation caused by elasticity of the control target; an operation exhibited by the control target at the time of axis inversion; an operation exhibited by the control target under the influence of a thermal displacement; an operation exhibited by the control target in response to a reaction force caused at the time of machining; an operation of position feedback loop processing performed within the controller that controls the control target; an operation of speed feedback loop processing performed within the controller; an operation of current feedback loop processing performed within the controller; an operation of processing performed within the controller to compensate for the influence of inertia; an operation of processing performed within the controller to compensate for the influence of the viscosity; an operation of processing performed within the controller to compensate for the influence of the elasticity; an operation of processing performed within the controller to compensate for the influence of the axis inversion; an operation of processing performed within the controller to compensate for the influence of the thermal displacement; an operation of processing performed within the controller to compensate for the influence of the reaction force caused at the time of machining; and an operation of filtering performed within the controller to smooth the command path.

Therefore, it is possible to generate a command path taking into consideration the error caused by the viscosity and elasticity that are the characteristics of the machine tool 103, the error caused by the axis inversion, the error caused by the reaction force caused at the time of machining, and the error caused by the response delay resulting from the feedback loop processing performed within the controller 102. In addition, since the command path is corrected in advance on the computer, the present invention can also be applied to a case where the cross-sectional shape of a non-true circular shape changes, or the like case.

The path comparison unit 26 is also configured to calculate the error between the response path and the target path held in the target path and tolerance range holding unit 22 on the basis of a position of a machining tool or a feedback position acquired from an actuator that operates the control target when the control target is actually operated in a non-machining state.

Therefore, even when modeling of the machine tool 103 is difficult, by virtue of generating a command individually for the error caused by the characteristics of the machine tool 103 that is the control target and the controller 102 and for the error associated with the disturbance caused by the machining method or the shape of the material before machining, test machining for acquiring the error at the time of machining need only be performed once and it is possible to significantly reduce the time required for generating the command path.

The machining error model input unit 23 is configured to calculate the machining error on the basis of any one of a measured result obtained when the control target is used to perform actual machining according to a command path generated so that a machining error becomes zero, a position of the machining tool, and a feedback position acquired from the actuator that operates the control target. Consequently, the error correction based on the result of actual machining can be performed with high accuracy.

The command value generator is configured to further include: a material shape input unit that receives a shape of the material before subjected to machining; and a material quality input unit that receives at least one of a type of the material to be machined and a physical property value of the material, wherein the machining error model input unit 23 is adapted to a disturbance the machining tool experiences at the time of machining being calculated and to receive the calculated disturbance, the disturbance being calculated on the basis of a material physical property value determined by information inputted to the material shape input unit and information inputted to the material quality input unit, and a command path generated so that a machining error becomes zero. Note that the material shape input unit and the material quality input unit correspond to the shape data input unit 11. As a result, with the computer calculating the disturbance at the time of machining, the errors including the machining error can be corrected without carrying out test machining.

Alternatively, the command value generator is configured to further include: a material shape input unit that receives a shape of the material before subjected to machining; a material quality input unit that receives at least one of a type of the material to be machined and a physical property value of the material; and a mechanical model input unit that receives at least one of a shape of the machining tool, a material quality of the machining tool, a physical property value of the material of the machining tool, a mechanistic model of a machine tool that is the control target, a physical property value of each mechanism of the machine tool, inertia of each mechanism of the machine tool, viscosity of each mechanism of the machine tool, and elasticity of each mechanism of the machine tool. The machining error model input unit 23 is adapted to a disturbance the machining tool experiences at the time of machining being calculated and to receive the calculated disturbance, the disturbance being calculated on the basis of a material physical property value determined by information inputted to the material shape input unit and information inputted to the material quality input unit, information inputted to the mechanical model input unit, and a command path generated so that a machining error becomes zero. Note that the material shape input unit, the material quality input unit, and the mechanical model input unit correspond to the shape data input unit 11. As a result, the machining error can be corrected more accurately by performing the calculation involving the information inputted from the mechanical model input unit.

The command value generator is configured to further include a machining error database 45 that has a correspondence relationship between a machining error and at least one of a machining method and a shape of the material before subjected to machining, wherein the machining error model input unit 23 refers to the machining error database 45 when receiving the machining method or the shape of the material before subjected to machining and reads a machining error corresponding to the inputted machining method or shape of the material before subjected to machining. As a result, with the use of the machining error database 45, the errors including the machining error can be corrected without carrying out test machining.

The target path and tolerance range input unit 21 or the target path and tolerance range changing unit 24 is configured to specify a range of tolerance for each section of the target path. As a result, the time required for command generation can be reduced while guaranteeing the required accuracy by decreasing the tolerance in a part where high accuracy is required and increasing the tolerance in a part where high accuracy is not required.

The target path and tolerance range input unit 21 or the target path and tolerance range changing unit 24 is configured to set whether correction is required or not for each section of the target path. As a result, correction is not performed on a section that is not actually machined in a case such as the case where the side of a workpiece has been cut off, so that the accuracy is increased more easily in a section requiring correction and the time required for command generation can be reduced.

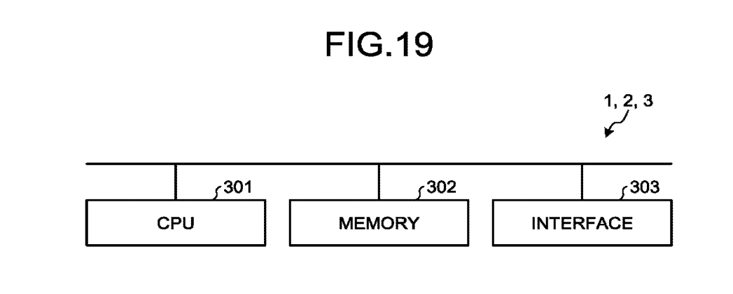

The command value generator 1 according to the first embodiment, the command value generator 2 according to the second embodiment, and the command value generator 3 according to the third embodiment may be formed of a CPU 301 performing calculation, a memory 302 storing a program read by the CPU 301, and an interface 303 inputting and outputting a signal as illustrated in FIG. 19.

Specifically, the shape data input unit 11, the tolerance input unit 12, the correction target axis input unit 13, the dwell/clearance input unit 14, the speed data input unit 15, the time constant data input unit 16, the machining error model input unit 23, 41, or 51, the command path output unit 28 or 54, and the response error model input unit 30 correspond to the interface 303.

The target path and tolerance range holding unit 22, the temporary command path holding unit 27 or 44, and the machining error database 45 correspond to the memory 302.

The memory 302 stores therein a program that executes functions of the target path and tolerance range generation unit 17, the target path and tolerance range input unit 21, the target path and tolerance range changing units 24, 42, or 53, the response path calculation unit 25 or 43, the path comparison unit 26, the command path correction unit 29, and the predicted machining error calculation unit 52.

The CPU 301 calculates an error between a response path and a target path, corrects a temporary command path when it is determined that the calculated error does not fall within a range of tolerance, and outputs a temporary command path obtained after the correction as a command path to the machining program generation unit 101 via the interface 303.

The configuration illustrated in the aforementioned embodiments illustrates an example of the content of the preset invention, and can thus be combined with other publicly known techniques and partially omitted or modified without departing from the gist of the present invention.

### REFERENCE SIGNS LIST

1, 2, 3 command value generator; 5 input unit; 6, 7, 8 command value generation unit; 11 shape data input unit; 12 tolerance input unit; 13 correction target axis input unit; 14 dwell/clearance input unit; 15 speed data input unit; 16 time constant data input unit; 17 target path and tolerance range generation unit; 21 target path and tolerance range input unit; 22 target path and tolerance range holding unit; 23, 41, 51 machining error model input unit; 24, 42, 53 target path and tolerance range changing unit; 25, 43 response path calculation unit; 26 path comparison unit; 27, 44 temporary command path holding unit; 28, 54 command path output unit; 29 command path correction unit; 30 response error model input unit; 31 machining result error measurement unit; 45 machining error database; 52 predicted machining error calculation unit; 101 machining program generation unit; 102 controller; 103 machine tool.

1-10. (canceled)

11: A command value generator comprising:
a target path and tolerance range holding unit to hold a target path on which a control target operates and a range of tolerance with respect to the target path;
a machining error model input unit to calculate a machining error in each section of the target path;
a target path and tolerance range changing unit to change at least one of the target path and the range of tolerance on the basis of the machining error;
a response path calculation unit to calculate a response error and a response path;
a path comparison unit to calculate an error between the response path and the target path and determine whether the calculated error falls within the range of tolerance;
a temporary command path holding unit to hold the target path as a temporary command path; and
a command path correction unit to correct the temporary command path,
wherein the command path correction unit corrects the temporary command path held in the temporary command path holding unit on the basis of the response error when it is determined that the error calculated by the path comparison unit does not fall within the range of tolerance, and a temporary command path obtained after the correction is held in the temporary command path holding unit.

12: The command value generator according to claim 11, further comprising:
a target path and tolerance range input unit to receive the target path and the range of tolerance; and
a command path output unit to output the temporary command path to an outside as a command path,
wherein the target path and tolerance range holding unit holds the target path and the range of tolerance received from the target path and tolerance range input unit.

13: The command value generator according to claim 11, wherein the path comparison unit calculates an error between the response path and the target path by simulating an operation of the control target and a controller that controls the control target with a model and a parameter which are required to simulate at least one of:
an operation caused by viscosity of the control target;
an operation caused by elasticity of the control target;
an operation exhibited by the control target at the time of axis inversion;
an operation exhibited by the control target under influence of a thermal displacement;
an operation exhibited by the control target in response to a reaction force caused at the time of machining;
an operation of position feedback loop processing performed within the controller;
an operation of speed feedback loop processing performed within the controller;
an operation of electric current feedback loop processing performed within the controller;
an operation of processing performed within the controller to compensate for influence of inertia;
an operation of processing performed within the controller to compensate for influence of the viscosity;
an operation of processing performed within the controller to compensate for influence of the elasticity;
an operation of processing performed within the controller to compensate for influence of the axis inversion;
an operation of processing performed within the controller to compensate for influence of the thermal displacement;
an operation of processing performed within the controller to compensate for influence of the reaction force caused at the time of machining; and
an operation of filtering performed within the controller to smooth the command path.

14: The command value generator according to claim 11, wherein the path comparison unit calculates an error between the response path and the target path on the basis of a position of a machining tool or a feedback position acquired from an actuator that operates the control target when the control target is actually operated in a non-machining state.

15: The command value generator according to claim 11, wherein the machining error model input unit calculates the machining error on the basis of any one of a measured result obtained when the control target is used to perform actual machining with a command path generated so that a machining error becomes zero, a position of the machining tool, or a feedback position acquired from the actuator that operates the control target.

16: The command value generator according to claim 11, further comprising:
a material shape input unit to receive a shape of a material before subjected to machining; and
a material quality input unit to receive at least one of a type of the material to be machined and a physical property value of the material,
wherein the machining error model input unit is adapted to a disturbance the machining tool experiences at the time of machining being calculated and to receive the calculated disturbance, the disturbance being calculated on the basis of a material physical property value determined by information inputted to the material shape input unit and information inputted to the material quality input unit, and a command path generated so that a machining error becomes zero.

17: The command value generator according to claim 11, further comprising:
a material shape input unit to receive a shape of a material before subjected to machining;
a material quality input unit to receive at least one of a type of the material to be machined and a physical property value of the material; and
a mechanical model input unit to receive at least one of a shape of the machining tool, a material quality of the machining tool, a physical property value of the material of the machining tool, a mechanistic model of a machine tool that is the control target, a physical property value of each mechanism of the machine tool, inertia of each mechanism of the machine tool, viscosity of each mechanism of the machine tool, and elasticity of each mechanism of the machine tool,
wherein the machining error model input unit is adapted to a disturbance the machining tool experiences at the time of machining being calculated and to receive the calculated disturbance, the disturbance being calculated on the basis of a material physical property value determined by information inputted to the material shape input unit and information inputted to the material quality input unit, information inputted to the mechanical model input unit, and a command path generated so that a machining error becomes zero.

18: The command value generator according to claim 11, further comprising a machining error database to have a correspondence relationship between a machining error and at least one of a machining method and a shape of the material before subjected to machining,
wherein the machining error model input unit refers to the machining error database when receiving the machining method or the shape of the material before subjected to machining, and reads a machining error corresponding to the inputted machining method or shape of the material before subjected to machining.

19: The command value generator according to claim 11, wherein the target path and tolerance range input unit or the target path and tolerance range changing unit specifies a range of tolerance for each section of the target path.

20: The command value generator according to claim 11, wherein the target path and tolerance range input unit or the target path and tolerance range changing unit sets whether correction is required or not for each section of the target path.

21: The command value generator according to claim 11, further comprising a predicted machining error calculation unit to calculate a predicted machining error in each section of a target path on the basis of information inputted from the machining error model input unit,
wherein the target path and tolerance range changing unit changes at least one of the target path and the range of tolerance on the basis of the predicted machining error in each section of the target path, inputted from the predicted machining error calculation unit.
